(19) United States
(12) Patent Application Publication
(10) Pub. No.: US 2025/0046550 A1
(43) Pub. Date: Feb. 6, 2025

(54) VACUUM SWITCH DEVICE AND METHOD FOR PRODUCING A VACUUM SWITCH DEVICE

(71) Applicant: Siemens Aktiengesellschaft, München (DE)

(72) Inventors: Thomas Brauner, Berlin (DE); Alexander Ziefle, Potsdam (DE); Frank Graskowski, Wandlitz (DE)

(21) Appl. No.: 18/696,489

(22) PCT Filed: Sep. 2, 2022
(86) PCT No.: PCT/EP2022/074442

§ 371 Date: Mar. 28, 2024

(30) Foreign Application Priority Data
Sep. 28, 2021 (DE) 10 2021 210 862.8

(51) Int. Cl. H01H 33/662; H01H 11/00; H01H 33/664

(52) U.S. Cl. CPC H01H 33/66238; H01H 11/00; H01H 33/664

(57) ABSTRACT

A vacuum switch device has a housing, at one end of which a fixed contact is arranged; a bellows, which is fastened on one side to a flange at the other end of the housing and on the other side to a moving contact; and a guide bearing for the moving contact. The bearing is fastened to the flange and guides the moving contact in a sliding manner. The guide bearing is secured on the flange by an adhesive layer. There is also described a method for producing a vacuum switch device.

The present invention relates to a vacuum switch device in accordance with the preamble of claim 1 and to a method for producing a vacuum switch device in accordance with the preamble of claim 13.

The instruction manual “3TM vacuum contactor 7.2 kV-15 kV, 3-pole, 4.15 kV-6.9 kV, 1-pole”, order no.: 9229 0106 0, Siemens AG 2020, discloses a medium-voltage switching unit comprising a vacuum switch device having an electromagnetic drive. The magnetic drive can exert a magnetic force on what is known as an armature plate and attract it. The movement of the armature plate is translated mechanically into a movement for pressing a moving contact against a fixed contact within the vacuum switch device. The moving contact is guided out of the vacuum via a flexible spring bellows.

The catalog “vacuum circuit breaker 3AH4”, article no. EMMS-K1511-A041-A6, Siemens AG 2018, discloses a vacuum switch device having a spring-loaded drive.

A vacuum switch device within the meaning of the invention has, for example, a fluidtight housing in whose interior a vacuum (or an extremely low gas pressure below 10-3 mbar, preferably below 10-6 mbar) prevails. Typically, the housing is partially formed as a ceramic insulating body made of aluminum oxide which is connected to further components of the housing at a metallic flange region. If a moving contact is quickly pulled away from the fixed contact, for example by means of a spring force, a resulting arc is quickly extinguished. Typically, the current is interrupted from time to time in the region of the zero crossing.

Vacuum switch devices are particularly well-suited for switching alternating current because an arc is always extinguished at the zero crossing of the current. The moving contact is guided out of the vacuum via a flexible spring bellows. In order to stabilize and center the moving contact rod, use is made of a guide bearing, preferably made of plastic, which is fastened to the flange of the moving contact.

Up until now, the guide bearing has been frequently fastened via a separate part, a bearing cap. The bearing cap is soldered on the flange of the moving contact during the soldering process and serves as a receptacle for the bearing. After inserting the plastic bearing, the upper edge of the bearing cap is, for example, folded over to fasten the bearing. Solutions are also known in which a kind of nozzle is drawn out of the flange and serves for fastening the bearing. Also known are bearings which, during mounting, snap into a locked state. For this purpose, the plastic bearing is configured in such a way that it comprises latch-in hooks which can latch in at the flange opening. This construction is, inter alia, mechanically less stable than the first specified solution.

Starting from previous vacuum switch devices, the object of the invention is to specify a vacuum switch device which can be manufactured in a comparatively simple and cost-effective manner and allows a long operating period.

The invention achieves this object by means of a vacuum switch device as claimed in claim 1.

The housing has, for example, a metallic flange as “cover” and a further metallic flange as “bottom” which are connected to a ceramic insulating body (for example made of aluminum oxide) in the form of a cylindrical jacket. The interior of the housing is evacuated.

A folding bellows is a corrugated component in the form of an accordion which can be compressed with little mechanical resistance and relaxed again and at the same time is fluidtight and durable. A folding bellows is manufactured, for example, from a thin metal sheet.

A flange is as a rule a metallic connecting part.

An adhesive layer within the meaning of the invention is a less than 5 mm thick layer with an adhesive which cures after application and allows a high mechanical strength with respect to tearing out when switching the vacuum switch device on and off and against torsional and bending movements when switching. The adhesive used can be at least partially an epoxy resin.

A guide bearing is a component for guiding the moving contact through the housing. The moving contact is typically in the form of a pin, and therefore the guide bearing provides an elongate hollow cylinder for receiving the pin. For cost reasons and on account of the good sliding properties of the material, the guide bearing is frequently produced from plastic and, for example, formed by injection molding or cutting. In such a case, the adhesive layer thus connects a guide bearing made of plastic to a flange made of metal.

The adhesive layer between the guide bearing and the flange has the advantage that previously required work steps in the manufacture can be dispensed with. Locking the plastic guide bearing on the flange with a metal sheet which is bent over radially inward for fixing is dispensed with. This allows quick and more cost-effective manufacture.

Furthermore, an essential advantage is that, by comparison with previous designs, an orientation of an anti-rotation safeguard between the rod and the bearing or a bearing receptacle can occur subsequent to a soldering process for producing the fluidtight housing. A further advantage is that, by virtue of the areal adhesive bonding, a particularly large mechanical stability is achieved, which increases the service life or operating period of the vacuum switch device. A longer service life or operating period in turn allows cost savings for the customer.

In a development of the vacuum switch device, additional mechanical stabilization can be achieved in that a mechanical locking device presses the guide bearing and the flange against one another and/or prevents the components from being pulled apart. This relieves the adhesive bond and ensures the mechanical stability, for example even in cases in which the adhesive layer could be loosened by heating during the operation of the vacuum switch device as a result of a current flow. The mechanical locking device can be formed, for example, as a so-called snap nose. This is a spring device which is secured at one of its two ends to a cylindrical stabilizing region of the guide bearing and projects therefrom in the longitudinal direction (coaxially to the direction in which the moving contact is guided), that is to say toward the contact surface. Projection means in this connection that there is a cavity between the spring device and the stabilizing region. As a result, the spring device can be pressed onto the stabilizing region by exerting a pressure from outside to inside, that is to say in the direction of the stabilizing region. Here, the spring device is dimensioned in such a way that it is compressed when pushing the guide bearing onto the flange. If the flange comes to lie on the contact surface with the adhesive layer, the spring device can snap out again with formation of the cavity and lock the flange in the manner of a barb. It is particularly preferable for the cavity between the spring device and the stabilizing region then also to be filled with the adhesive. After curing, the locking can no longer be released.

By comparison with previous solutions in which a metal sheet was used for locking, the contact region to the flange is no longer hollow but designed to be solid to form a contact surface for the adhesive.

In a preferred embodiment of the vacuum switch device according to the invention, the vacuum switch device is designed for low voltage. Low voltage within the meaning of the invention is characterized by an electrical voltage up to 1 kV.

In a preferred embodiment of the vacuum switch device according to the invention, the vacuum switch device is designed for medium voltage. Medium voltage within the meaning of the invention is characterized by an electrical voltage of between 1 kV and 52 kV.

In a preferred embodiment of the vacuum switch device according to the invention, the vacuum switch device is designed for high voltage. High voltage within the meaning of the invention is characterized by an electrical voltage above 52 kV.

In a preferred embodiment of the vacuum switch device according to the invention, the guide bearing has a roughened contact surface on its side facing the flange. Roughened within the meaning of the invention means that a smooth surface is no longer present. A roughened contact surface has, for example, projections and/or depressions with a height or depth of more than 0.1 mm. A roughened contact surface offers the advantage that a larger surface is provided for an adhesive, with the result that a larger mechanical loadability of the adhesive bond is achieved.

In a further preferred embodiment of the vacuum switch device according to the invention, the flange has a roughened contact surface on its side facing the guide bearing. Roughened within the meaning of the invention means that a smooth surface is no longer present. A roughened surface has, for example, projections and/or depressions with a height or depth of more than 0.1 mm. A roughened surface of the flange offers the advantage that a larger surface is provided for an adhesive, with the result that a larger mechanical loadability of the adhesive bond is achieved.

In a further preferred embodiment of the vacuum switch device according to the invention, the contact surface has projections. Projections within the meaning of the invention are elevations of any desired shape by comparison with the plane of the contact surface, these elevations being, for example, at least one mm high. If depressions are provided on the contact surface, all non-depressed regions correspond to projections within the meaning of the invention. Projections are advantageous because they provide a particularly highly roughened surface for the adhesive and thus further increase the adhesive force.

If the moving contact is pin-like in form, the guide bearing can, for example, also be designed to be radially symmetrical. In such a case, the contact surface forms, for example, an annularly encircling surface.

In a further preferred embodiment of the vacuum switch device according to the invention, the projections are at least partially arranged transversely with respect to the circumferential direction of the contact surface. The circumferential direction of the contact surface refers to the fact that the guide bearing engages around the moving contact, that is to say forms a circumferential surface for contacting the flange. In the case of a radially symmetrical configuration of the guide bearing, this circumferential direction can correspond to a circular path on the contact surface. In another geometrical configuration of the guide bearing, the circumferential direction can also be designed to run around in a multi-angled or polygonal manner. Longitudinally with respect to the circumferential direction corresponds to an orientation of the projections with their long side along the circumference around the moving contact, which for the adhesive bonding offers comparatively less resistance for strength against rotational movements. Longitudinal comprises, for example, an orientation of 0° to +/−30° relative to the circumferential direction. Transversely with respect to the circumferential direction corresponds to an orientation of the projections with their short side along the circumference around the moving contact, and thereby their long side presents for the adhesive bonding and offers a comparatively large resistance with respect to rotational movements. Transversely comprises, for example, an orientation of +/−60° to 90° relative to the circumferential direction.

In a further preferred embodiment of the vacuum switch device according to the invention, the projections are at least partially corrugated in form. This is an advantage because corrugated projections can be manufactured in a simple manner by plastic injection molding methods for the guide bearing.

In a further preferred embodiment of the vacuum switch device according to the invention, the projections are at least partially cuboidal in form. This is an advantage because corrugated projections can also be manufactured in a simple manner by plastic injection molding methods for the guide bearing.

In a further preferred embodiment of the vacuum switch device according to the invention, the flange has, on its side facing the guide bearing, depressions which are formed in a complementary manner to the projections on the guide bearing. A complementarily configured surface of the flange offers the advantage that projections and depressions can engage in one another, which allows particularly strong resistance against torsional forces when switching. The mechanical loadability of the adhesive bond is further improved. Advantageously, in one development, adhesive gaps can be provided between the depressions and the projections, with the result that the adhesive can furthermore wet the entire surface of the two components to be connected.

In the embodiments explained at the outset, projections are provided on the guide bearing and, where appropriate, depressions are provided on the flange. However, also providing projections on the flange and, where appropriate, depressions on the guide bearing is equally preferable and can also be implemented technically in a simple manner.

In a further preferred embodiment of the vacuum switch device according to the invention, the guide bearing has cutouts arranged on the contact surface and intended to receive excess adhesive. This is an advantage because, when pressing the guide bearing onto the flange in the manufacture, a uniformly thick adhesive layer is always formed.

In a further preferred embodiment of the vacuum switch device according to the invention, the cutouts are formed as at least one annularly encircling groove.

In a further preferred embodiment of the vacuum switch device according to the invention, the guide bearing has, on the outer edge of the contact surface, a boundary wall which protrudes at least just as high beyond the contact surface as the projections, and at least one barrier wall is arranged on that side of the contact surface facing the moving contact and protrudes at least just as high beyond the contact surface as the projections, wherein the barrier wall encloses a throughflow opening for a fluid, and wherein the throughflow opening is arranged between the guide bearing and the moving contact. This has the advantage that the boundary wall and the barrier wall together form an enclosure for the adhesive layer and thus prevent spreading of excess adhesive during the manufacture.

In a further preferred embodiment of the vacuum switch device according to the invention, the contact surface has at least one adhesive opening for receiving adhesive. It has been shown in tests that in particular a wetting of the inner walls of openings in the contact surface after curing of the adhesive increases the mechanical loadability of the adhesive bond. In the simplest case, the adhesive openings are bores. It is particularly preferred if, during production, such a quantity of adhesive is applied that the adhesive is pressed through the at least one adhesive opening onto the rear side (or the side of the guide bearing that faces away from the contact surface). A lance of the adhesive is then formed in the opening and, outside the opening, on the rear side, a thickening. Thus, the adhesive forms a rivet-like or mushroom-like shape on the adhesive opening, which increases both the security against rotation and the tear-out strength of the adhesive bond.

In a further preferred embodiment of the vacuum switch device according to the invention, the guide bearing has a stabilizing part which tapers in the direction of the fixed contact and on which is arranged a radially inwardly bendable spring part which, in the mounted state, provides a clamping seat of the flange on the contact surface of the guide bearing and/or on an inner side of the spring bellows. This additional locking further increases the mechanical strength in conjunction with the adhesive layer.

In a further preferred embodiment of the vacuum switch device according to the invention, the guide bearing and/or the flange have or has locking elements for the form-fitting connection between the guide bearing and the flange. For example, latches and cutouts can be used as locking elements. A bayonet closure can also be formed by means of the guide bearing and/or the flange. As a result, the mechanical stability, in particular under temperature loading, can be still further increased.

Starting from previous methods for producing a vacuum switch device, the object of the invention is also to specify a method for producing a vacuum switch device that is comparatively simple and cost-effective and also allows a long operating period of the vacuum switch device.

The invention achieves this object by means of a vacuum switch device as claimed in claim 13. Preferred embodiments of the production method according to the invention are explained in dependent claims 14 and 15. The same advantages as described at the outset for the vacuum switch device according to the invention result here analogously in each case.

To better explain the invention,

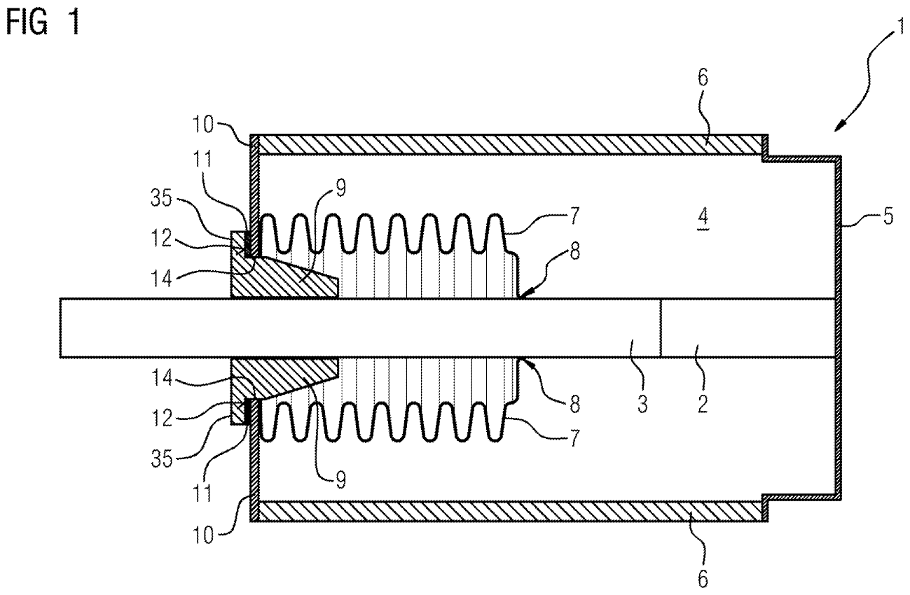

FIG. 1 schematically shows an exemplary embodiment of a vacuum switch device according to the invention, and

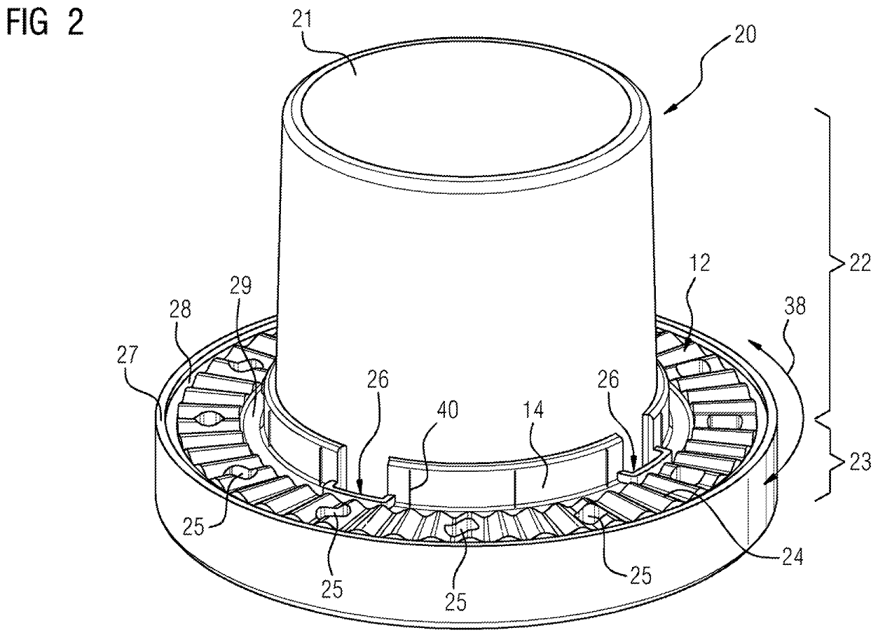

FIG. 2 schematically shows a first exemplary embodiment of a guide bearing, and

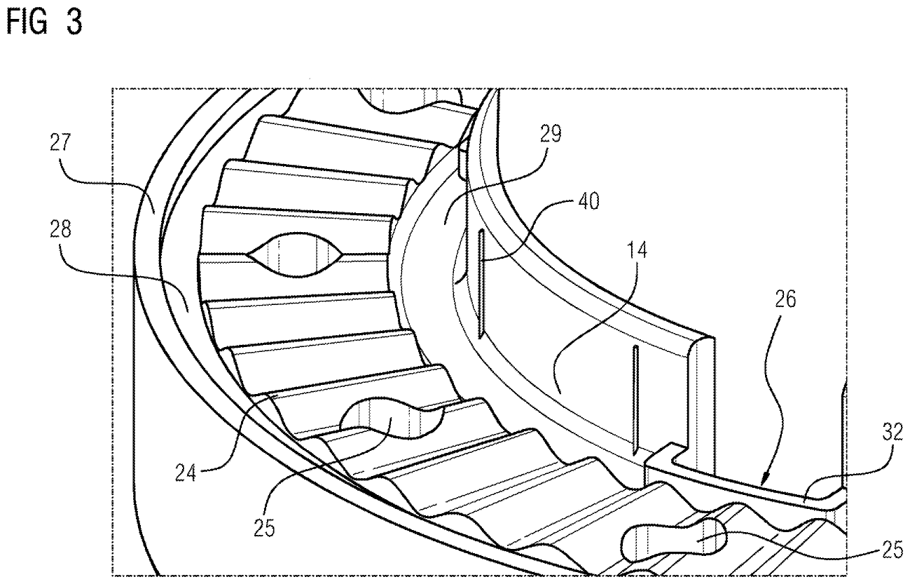

FIG. 3 schematically shows a detail view of the guide bearing according to FIG. 2, and

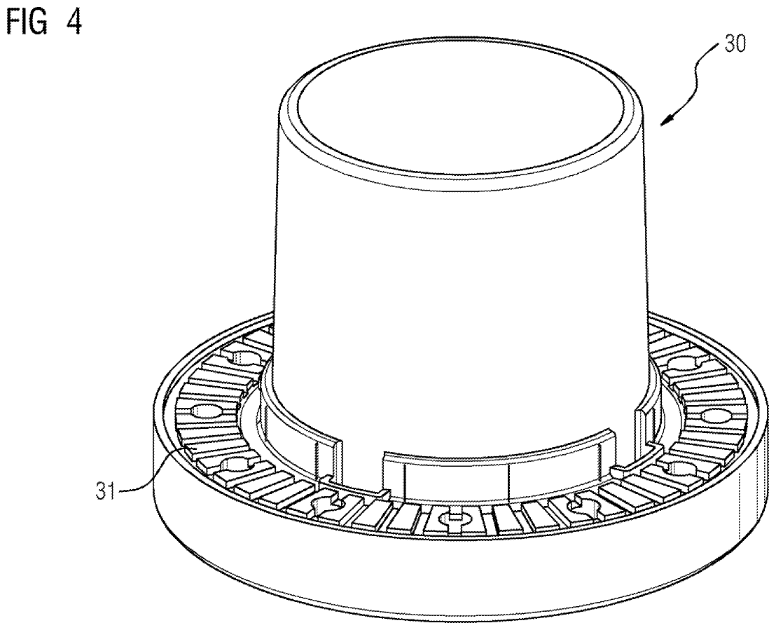

FIG. 4 schematically shows a second exemplary embodiment of a guide bearing, and

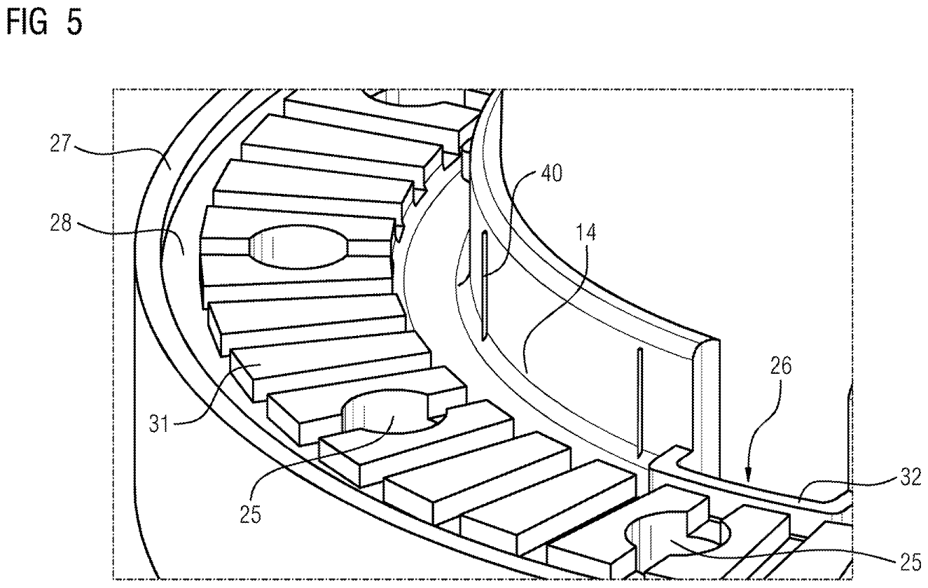

FIG. 5 schematically shows a detail view of the guide bearing according to FIG. 5, and

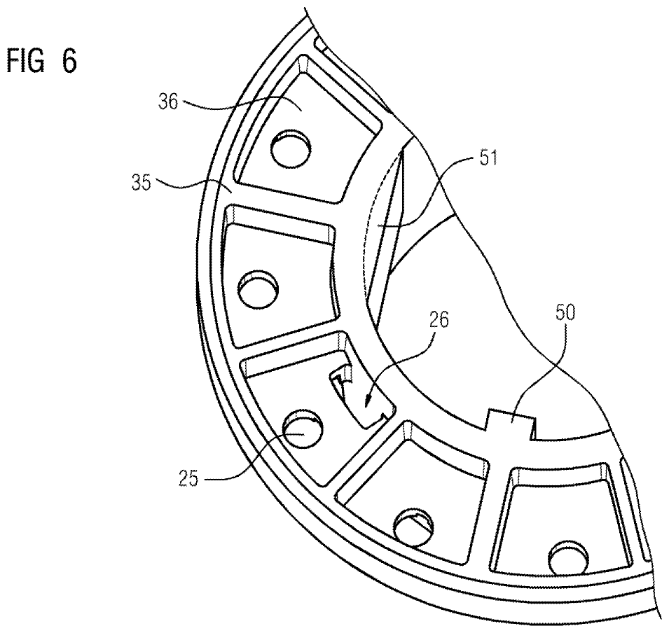

FIG. 6 schematically shows a detail view of a side of a guide bearing that faces away from the contact surface, and

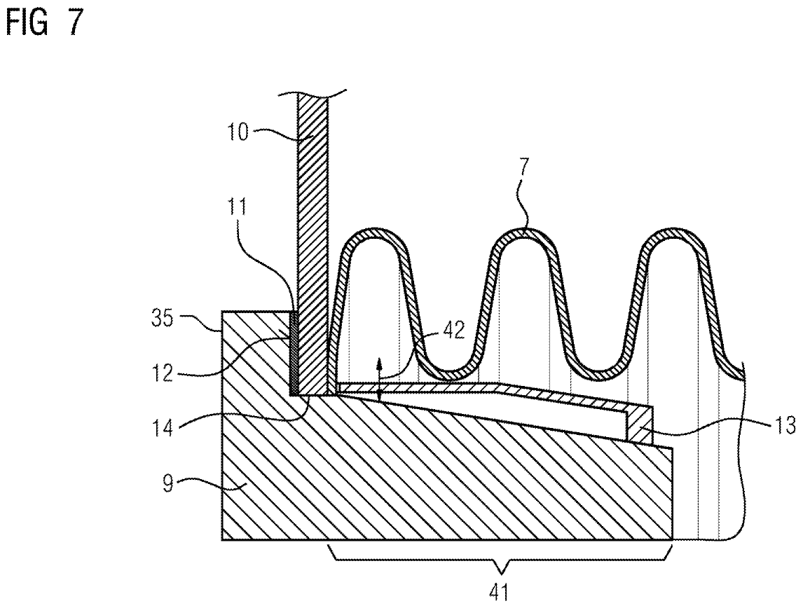

FIG. 7 schematically shows a detail view of a guide bearing with a spring part.

In the following figures, components having the same function are provided with the same reference signs.

FIG. 1 shows an exemplary embodiment of a vacuum switch device 1 according to the invention having a metallic cover 5 on which a fixed contact 2 is mounted in the interior of the vacuum switch device 1. The cover 5 adjoins a ceramic insulating body 6 made of aluminum oxide. The insulating body 6 in turn is connected to a metallic flange 10. The 17 cover 5, the ceramic insulating body 6 and the flange 10 form a fluidtight housing for the vacuum switch device 1. In the illustrated switched-on state of the switch device 1, a moving contact 3 contacts the fixed contact 2. The moving contact 3 is fixedly connected to a metallic spring bellows 7 at the mounting point 8. The metallic spring bellows 7 adjoins the flange 10 at its other end in a fluidtight manner. The interior of the housing is evacuated such that the region 4 in which the contacts 2, 3 contact or approach one another can be kept evacuated.

The moving contact 3 can be pulled away from the fixed contact 2 in order to disconnect the conducting connection. To allow this, the moving contact is mounted in a guide bearing 9 such that it can be displaced in a sliding manner. The guide bearing 9 has a step 14 on which the flange 10 is seated. The guide bearing 9 forms a contact surface 12 to the flange 10, which contact surface is provided with an adhesive layer 11. On the side facing away from the adhesive layer, a rear side 35 of the guide bearing is formed.

FIG. 2 shows a first exemplary embodiment of a guide bearing 20. The guide bearing 20 has a hollow-cylindrical opening 21 for receiving the moving contact. In a stabilizing region 22, the diameter of the hollow cylinder tapers in the direction of the fixed contact. Connected to the stabilizing region 22 is an attachment region 23 which is provided to form an adhesive bond with the flange. For this purpose, the attachment region 23 has a contact surface 12 which is formed in the circumferential direction 38 in an annularly encircling manner. Corrugated projections 24 are arranged on the contact surface 12. The corrugated projections 24 allow a particularly good and stable adhesive connection to the flange if, during the production process, an adhesive layer is applied to the corrugated profile 24. The contact surface 12 has a plurality of adhesive openings 25 through which excess adhesive can be pressed during the production process. Said adhesive can reach the rear side 35 (not shown) and form a rivet- or mushroom-like shape. This further increases the mechanical stability of the adhesive bond. The step 14 has a plurality of anti-slip means 40 which are formed as small and comparatively thin webs. The webs 40 make it possible, when pressing the flange 10 onto the step 14 or the webs 40, to achieve further improved torsional strength or slip resistance of the connection.

A plurality of throughflow openings 26 are provided which allow a fluid exchange with the surroundings when switching. The non-evacuated region between the folding bellows, the guide bearing and the moving contact is connected in this way to the surroundings.

Depending on the configuration and application field of the vacuum switch device, a gas such as air or an electrical insulating gas such as sulfur hexafluoride or dried compressed air can thus be exchanged with the surroundings.

For certain use purposes, an insulating oil or the like can be removed through the throughflow openings. At the outer 8 edge of the contact surface 12 there is provided a boundary wall 27 which protrudes at least just as high beyond the contact surface 12 as the projections 24. It thus constitutes a barrier such that no excess adhesive can be spread outwardly.

Two cutouts 28, 29 are provided which serve to receive excess adhesive. The two cutouts 28, 29 are formed as circumferential grooves and enclose the corrugated profiled region 24 on both sides.

FIG. 3 shows a detail view of FIG. 2, wherein in particular a barrier wall 32 for the throughflow opening 26 can be seen. The barrier wall 32 is arranged on that side of the contact surface 12 which faces the moving contact and protrudes at least just as high beyond the contact surface 12 as the projections 24. The barrier wall 32 thus allows the throughflow opening to be shielded with respect to excess adhesive and thus ensures that excess adhesive cannot block the throughflow openings 26 during the production of the vacuum switch device.

FIG. 4 shows a guide bearing 30 in which another type of projections by comparison with FIG. 2 has been selected. They are cuboidal elements which point away radially outward. These cuboidal projections 31 also form a very good slip resistance for the adhesive layer.

FIG. 5 shows a detail view of FIG. 4.

FIG. 6 shows a detail view of a side of a guide bearing that faces away from the contact surface, or a rear side 35 according to FIG. 1. The throughflow openings 26 and the adhesive openings 25 can be seen. The adhesive openings 25 and the throughflow openings 26 open into depressions 36 on the rear side 35.

There can also be seen guide means 50, 51 which serve to guide a complementarily shaped moving contact 3 in a torsionally secure manner. The guide means 50 is a projection having a rectangular cross section, whereas the guide means 51 is formed as a region which is flattened with respect to the circular path.

FIG. 7 shows a detail view of a guide bearing 9 having a spring part 13. The guide bearing 9 has a stabilizing part 41 which tapers in the direction of the fixed contact and on which is arranged a spring part 13 which can be bent radially inward in direction 42 and which, in the illustrated mounted state, provides a clamping seat of the flange 10 on the contact surface 12 of the guide bearing 9 and/or on an inner side of the spring bellows 7. This additional locking further increases the mechanical strength in conjunction with the adhesive layer 11.

1-15. (canceled)

16. A vacuum switch device, comprising:
a housing having a fixed contact arranged at one end of said housing and a flange at another end of said housing;
a folding bellows having one side fastened to said flange and another side fastened to a moving contact; and
a guide bearing for said moving contact, said guide bearing being fastened to said flange and configured to guide said moving contact for sliding displacement thereof; and
an adhesive layer securing said guide bearing on said flange.

17. The vacuum switch device according to claim 16, wherein said guide bearing has a roughened contact surface on a side facing said flange.

18. The vacuum switch device according to claim 17, wherein said contact surface is formed with projections.

19. The vacuum switch device according to claim 18, wherein said projections are arranged at least partially transversely with respect to a circumferential direction of said contact surface.

20. The vacuum switch device according to claim 18, wherein said projections are at least partially corrugated in form.

21. The vacuum switch device according to claim 18, wherein said projections are at least partially cuboidal in form.

22. The vacuum switch device according to claim 18, wherein said flange, on the side facing the guide bearing, is formed with depressions formed complementarily to said projections on the guide bearing.

23. The vacuum switch device according to claim 17, wherein said guide bearing is formed with cutouts on said contact surface for receiving excess adhesive.

24. The vacuum switch device according to claim 23, wherein said cutouts are formed as at least one annularly encircling groove.

25. The vacuum switch device according to claim 17, wherein:
said guide bearing, at an outer edge of said contact surface, has a boundary wall which protrudes above said contact surface at least as high as said projections; and
at least one barrier wall is arranged on a side of said contact surface facing said moving contact and said at least one barrier wall protrudes above said contact surface at least as high as said projections; and
said at least one barrier wall encloses a throughflow opening for a fluid, with said throughflow opening being arranged between said guide bearing and said moving contact.

26. The vacuum switch device according to claim 16, wherein said contact surface is formed with at least one adhesive opening for receiving adhesive.

27. The vacuum switch device according to claim 16, wherein said guide bearing has a stabilizing part which tapers in a direction of said fixed contact and a radially inwardly bendable spring part on said stabilizing part which, in a mounted state, provides a clamping seat of said flange on said contact surface of said guide bearing and/or on an inner side of said folding bellows.

28. A method for producing a vacuum switch device, the method comprising the following steps:
providing a housing having a fixed contact arranged at a first end of the housing; and
providing a folding bellows which has one side fastened to a flange at a second end of the housing and another side fastened to a moving contact; and
providing a guide bearing for the moving contact;
applying an adhesive layer to at least one of the guide bearing or the flange and pressing the guide bearing onto the flange for securing the guide bearing on the flange, with the guide bearing being disposed as a bearing for sliding displacement of the moving contact.

29. The method according to claim 28, which comprises providing the guide bearing with a contact surface having projections on a side facing the flange.

30. The method according to claim 29, which comprises pushing the guide bearing along the moving contact in a direction towards the fixed contact by way of a stabilizing part which tapers in the direction towards the fixed contact, wherein a radially inwardly bendable spring part is bent inward by the flange until the contact surface is pressed on the flange, whereupon the spring part snaps back radially outward and provides a clamping seat of the flange on at least one of the contact surface of the guide bearing or on an inner side of the spring bellows.
